(19) United States
(12) Patent Application Publication
(10) Pub. No.: US 2011/0270928 A1
(43) Pub. Date: Nov. 3, 2011

(54) DATA SHARING OPERATION BETWEEN STORAGE DEVICE AND HOST GROUP

(75) Inventor: Gary Kung, Santa Ana, CA (US)

(73) Assignee: I/O INTERCONNECT, LTD., Santa Ana, CA (US)

(21) Appl. No.: 13/088,568

(22) Filed: Apr. 18, 2011

Related U.S. Application Data
(60) Provisional application No. 61/329,670, filed on Apr. 30, 2010.

(51) Int. Cl. G06F 15/16

(52) U.S. Cl. 709/205

(57) ABSTRACT

A data sharing method suitable for a storage device and a host group having a plurality of hosts is provided by the present invention. The data sharing method of the present invention is to check whether or not an identification code of the storage device is accepted, when the storage device links to one of the hosts. When the identification code of the storage device is accepted, the present invention defines the host linking with the host as a server host and the rest of hosts without linking the storage device as a client host. Then, the present invention broadcasts a notification to the client hosts from the server host, so as to perform a data sharing operation for sharing a data with a sharable status of the storage device to the client host through the server host.

### CROSS-REFERENCE TO RELATED APPLICATIONS

The application claims priority of U.S. provisional patent application Ser. No. 61/329,670 filed on Apr. 30, 2010, the contents of which are hereby incorporated by reference.

### FIELD OF THE INVENTION

The present invention relates to a data sharing operation, and more particularly to a data sharing operation between a storage device and a host group having a plurality of hosts.

### BACKGROUND OF THE INVENTION

FIG. 1A is a block diagram of a conventional data sharing system. Referring to the FIG. 1, the conventional data system 100 comprises a computer A 102 and a computer B 104. Wherein, the computer A 102 links to the computer B 104 through a local network 106. When a user wants to share a data 112 to the computer B 104, the data 112 needs to be copied first. Then, the copy of data is saved into the computer B 104. Therefore, another user can operate the data 112 on the computer B 104.

FIG. 1B is a block diagram of another convention data sharing system. Referring to the FIG. 1B, following the cloud technology development, the data sharing operation also can implement by the cloud server 122. In detail, if a user wants to share the data 112 to the computer B 104 from the computer A 102, the user needs to upload a copy of the data 112 to the server 112. Then, the copy of data 114 would be transmitted and saved into the computer B for completing the data sharing operation.

No matter the convention data sharing systems in FIG. 1A or 1B is used, the data sharing operation needs to occupy the storage space of destination computer, such as computer B 104. In another word, if the destination computer has insufficient storage space, the data sharing operation may be failure. In addition, the conventional data sharing operation is performed artificially. If someone has insufficient knowledge of computer, he/she cannot complete the data share operation by self.

### SUMMARY OF THE INVENTION

Therefore, the present invention is to provide a storage media, in which a control application program is saved for perform data sharing automatically.

The present invention further provides a data sharing method which can perform data sharing operation without occupying the storage space of the destination end.

A storage media which has a control application program adapted for a host is provided by the present invention. The control application program would check whether or not a storage device links to the host, when the control application program is installed into the host. When the storage device links to the host, the control application program checks whether or not an identification code of the storage device is accepted. When another host links to the host linking to the storage device, the host linking with the host is defined as a server host and another host without linking the storage device is defined as a client host. In addition, if the identification code of the storage device is accepted, the control application program makes the server host to share a data with a sharable status of the storage device to the client host.

From another viewpoint, a data sharing method suitable for a storage device and a host group having a plurality of hosts is provided by the present invention. The data sharing method of the present invention is to check whether or not an identification code of the storage device is accepted, when the storage device links to one of the hosts. When the identification code of the storage device is accepted, the present invention defines the host linking with the host as a server host and the rest of hosts without linking the storage device as a client host. Then, the present invention broadcasts a notification to the client hosts from the server host, so as to perform a data sharing operation for sharing a data with a sharable status of the storage device to the client host through the server host.

Because the control application program would make the server host sharing the data with the sharing status to the client host automatically as the storage device connecting to the server host, it is simple for some users having insufficient computer knowledge to share data saved in the storage device.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a block diagram of a first conventional data sharing system.

FIG. 1B is a block diagram of a second convention data sharing system.

FIG. 2 is a block diagram of a data sharing system according to one preferred embodiment of the present invention.

FIG. 3 is a system block diagram of a host according to one preferred embodiment of the present invention.

FIG. 4 is a flow chart of a data sharing method according to one preferred embodiment of the present invention.

FIG. 5 is a flow chart of the steps of sharing the data with the sharable status to the client hosts according to one preferred embodiment of the present invention.

FIG. 6 is a flow chart of the steps of interrupting to stop sharing data to the client hosts according to one preferred embodiment of the present invention.

FIG. 7 is a block diagram of the sharing system according to another embodiment of the present invention.

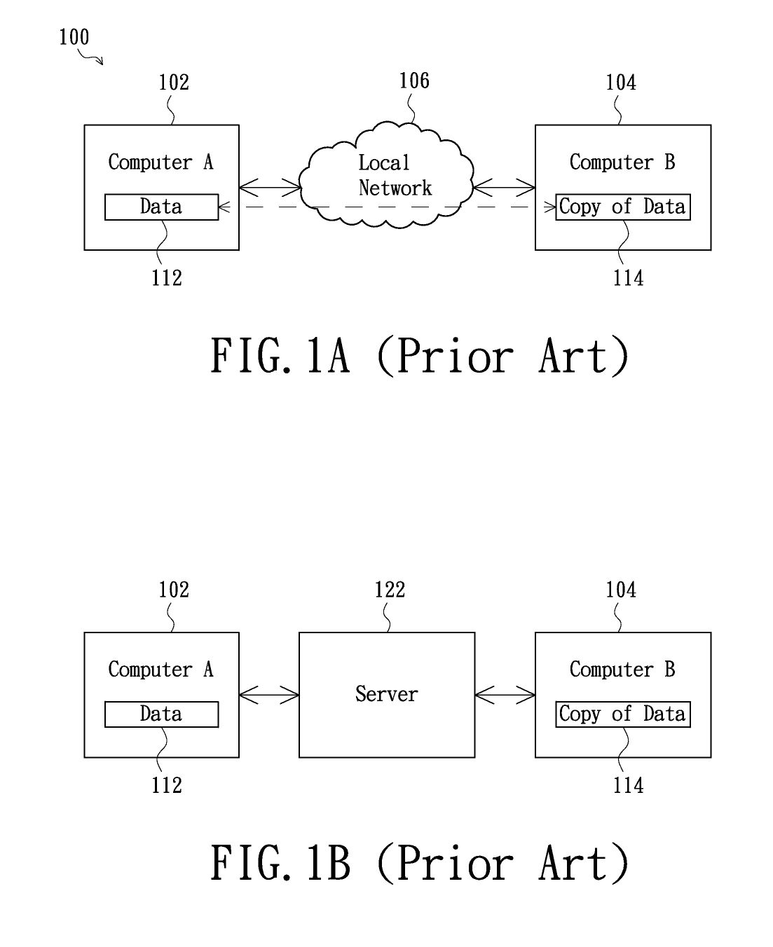

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

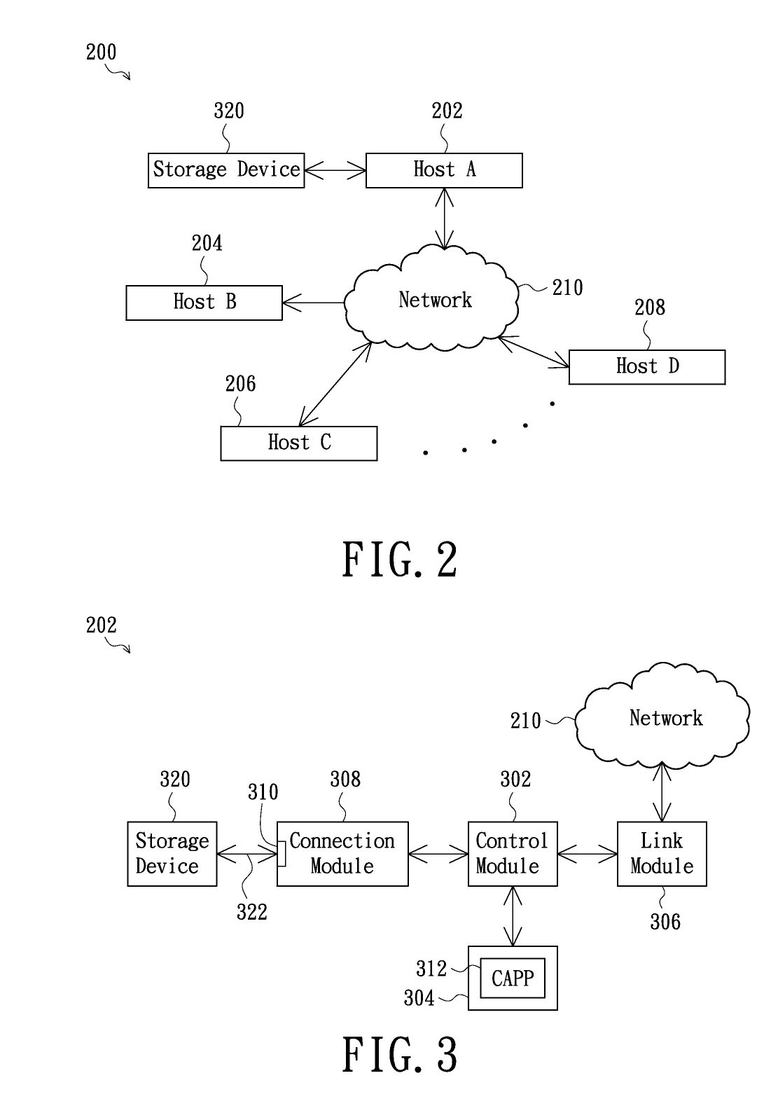

FIG. 2 is a block diagram of a data sharing system according to one preferred embodiment of the present invention. Referring to the FIG. 2, the data sharing system 200 comprises a host group, which is consisted of a plurality of host, such as host A 202, host B 204, host C 206 and host D 208. In the data sharing system 200, the host A 202, host B 204, host C 206 and host D 208 are linked by each other through the network 210. The network 210 is probably a wireless network or a wire network, such like a local network.

In some embodiments, each of the hosts in the data sharing system 200 is probably a personal computer, a pocket computer, a smart phone, a tablet computer, etc. FIG. 3 is a system block diagram of the host A 202 according to one preferred embodiment of the present invention. Following description takes the host A 202 as the example to explain the structure of a host. Referring to the FIG. 3, the host A 202 has a control module 302, storage unit 304 and link module 306. The control module 302 is coupled to the storage unit 304 and the link module 306. Wherein, the link module 306 links to the network 210. In this exemplary embodiment, the storage unit 304 is probably a hard disk, a flash memory, etc. Specially, a control application program (CAPP) 312 is installed into the storage unit 304. In some embodiments, the CAPP 312 is installed from a storage media, such as an optical storage media, a memory card, etc. In other embodiments, the CAPP 312 is saved in an external storage equipment originally, such like the storage device 320. When the external storage equipment (e.g., storage 320) links to the host A 202, the CAPP 312 is installed into the storage unit 304 automatically.

In addition, the host A 202 further has a connection module 308, which is coupled to the control module 302. The connection module 308 has a connection port 310, such as a USB port or a PCMCIA port. In other embodiments, the connection module 308 is implemented by an interface card, such like the PCIe card. Furthermore, the connection module 308 can be also implemented by a wireless transceiver or a card reader module.

Referring to the FIG. 3 continually, in this embodiment, when the storage device 320 links to the connection module 308 through a data transmission interface 322, the CAPP 312 would control the host A 202 to perform a data sharing operation. Wherein, the storage device 320 is probably an external flash memory device with USB connector, an external hard disk, a memory card, etc.

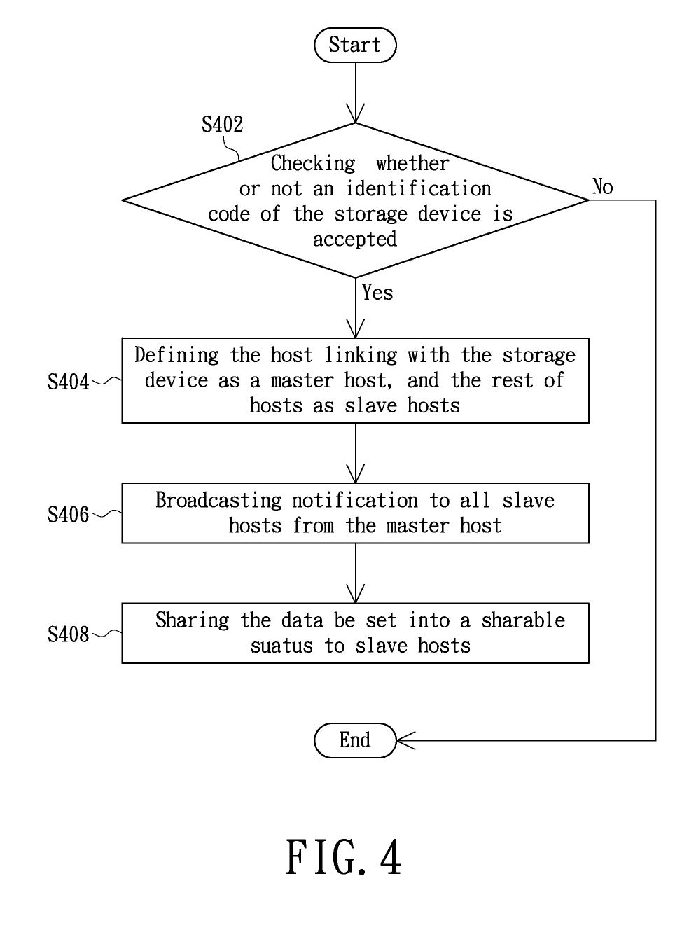

FIG. 4 is a flow chart of a data sharing method according to one preferred embodiment of the present invention. Referring to the FIGS. 3 and 4 together, when the storage device 320 is linked to the connection module 308 through the data transmission interface 322, the CAPP 312 would perform the step 5402 to check whether or not an identification code of the storage device, such as a production serial number, a vendor code, or other codes, is accepted. In the step 5402, the CAPP 312 can determine whether or not the identification code of the storage device 320 is a predetermined code. In other embodiments, the CAPP 312 can also determine whether or not the identification code of the storage device 320 is conformed to a predetermined rule or in a predetermined range.

If the CAPP 312 determines that the identification code of the storage device 320 is unaccepted (i.e. the “No” labeled on the step S402), the CAPP 312 wouldn't perform the rest of procedures in FIG. 4. On the contrary, if the identification code of the storage device 320 is accepted (i.e. the “Yes” labeled on the step S402), as the description in the step S404, the CAPP 312 would define the host which links with the storage device 320, such as the host A 202, as a server host. In addition, the CAPP 312 defines the rest of hosts without linking with the storage device 320, such like host B 304, host C 306 and host D 308 in FIG. 2, as client hosts. Therefore, the CAPP 312 controls the control module 302 generating a notification to the link module 306, and broadcasting the notification to the client hosts from the link module 306 through the network 210, as description in the step S408, for performing the step S408 to share a data, which is set a sharable status and saved into the storage device 320, to the client hosts.

In the exemplary embodiment, the data with the sharable status is probably a single file, or a file folder. In addition, the classification of the data with the sharable status is at least one of a video file, a music file, a document file, etc. Furthermore, the status of the data saved in the storage device 320 being set into the sharable status is determined as the vendor of the CAPP 312. In other embodiments, the CAPP 312 further provides a setting window on a screen of the server host 202. Therefore, a user can operate the setting window through the server host 202 to determine the status of the data saved into the storage device 320 as the sharable status or not by self.

Since the all procedures shown in the FIG. 4 are performed by the control application program of the present invention automatically, anyone even having insufficient knowledge of computer has ability to share data easily. In another word, the user just links the storage device with any hosts, the control application program of the present invention would perform the data sharing operation to share the data saved into the storage device to other user automatically.

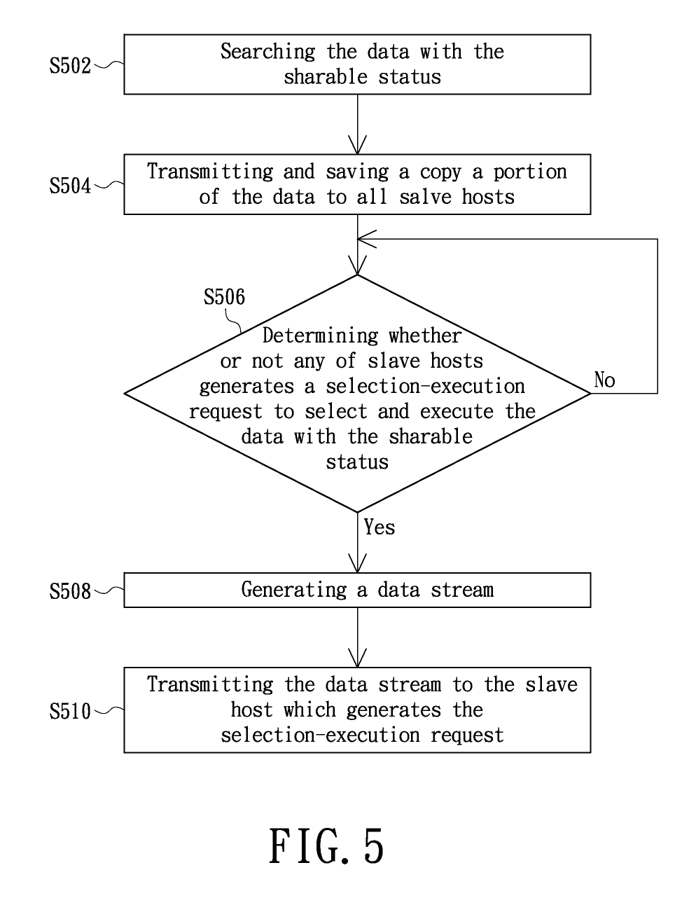

FIG. 5 is a flow chart of the steps of sharing the data with the sharable status according to one preferred embodiment of the present invention. Referring to the FIGS. 3 and 5 together, seeing the step S408 in FIG. 4 clearly. When the identification code of the storage device 320 is accepted, the CAPP 312 would further perform the step S502 to search the data with the sharable stats. Then, as the description in the step S504, the CAPP controls the control module 302 transmits and saves just a copy of a portion of the data to all client hosts during an initial sharing period, so as to save time for transmitting data. In this exemplary embodiment, the portion of the data with the sharable status transmitted to the client hosts during the initial sharing period comprises file name, fixing date, file classification and file size.

Then, the CAPP 312 as description in the step S506 determines whether or not any of the client hosts generates a selection-execution request for selecting and executing the data with the sharable status. When the CAPP 312 determines at least one of the client hosts generates the selection-execution request (i.e. “Yes” labeled on the step S506), the CAPP 312 would generate a data stream of the data being selected by corresponding client host, as description in the step S508. Then, the CAPP 312 makes the control module 302 transmits the data stream to corresponding client host which generates the selection-execution request, as the description in the step S510.

In other embodiments, during the initial sharing period, the CAPP 312 also can transmit the copy of complete data with the sharable status to all of client hosts during the initial sharing period. Therefore, the user can execute the data, which is saved in the storage device 320 originally, on the local end of any of the client hosts.

In some embodiments, when the user wants to stop sharing the data saved in the storage device 320 to the client hosts, the user just needs interrupting the link between of the storage device 320 and the server host 202. In other embodiments, an interruption procedure is provided as following.

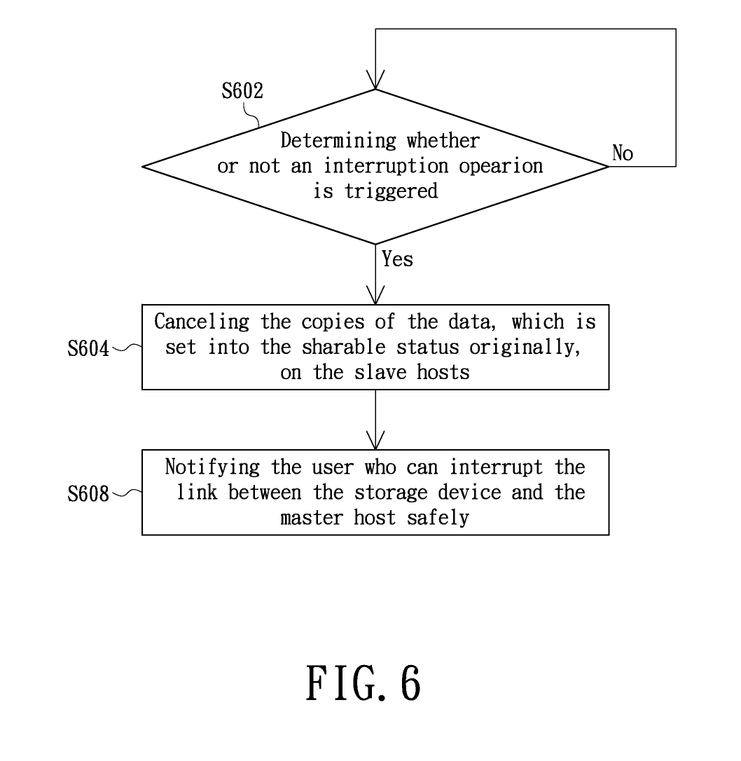

FIG. 6 is a flow chart of the steps of interrupting to stop sharing data to the client hosts according to one preferred embodiment of the present invention. Referring to the FIGS. 3 and 6, the CAPP 312 would determine whether or not an interruption operation is triggered continually, as description in the step S602. Wherein, the interruption operation comprises interrupting the link between the storage device and the server host, changing the status of the data into an unsharable status, enabling an interruption option provided by the CAPP 312, etc. If the CAPP 312 determine that the interruption operation is triggered (i.e “Yes” labeled on the step S602), the step S604 is carried out by the CAPP 312 to cancel the copies of the data, which is set into the sharable status originally, on the client hosts. Then, in some embodiments, the step S606 is performed by the CAPP 304 to notify the user who can break the link between the storage device 320 and the server host 202 safely.

Due to the CAPP 312 just transmits the copy of the portion of the data with the sharable status to all client hosts during the initial sharing period, the client hosts only need a little storage space for the data sharing operation. In addition, the copy is canceled as the sharing operation being stopped, the storage space of the client hosts wouldn't be occupied. Furthermore, the speed of the sharing operation can promote.

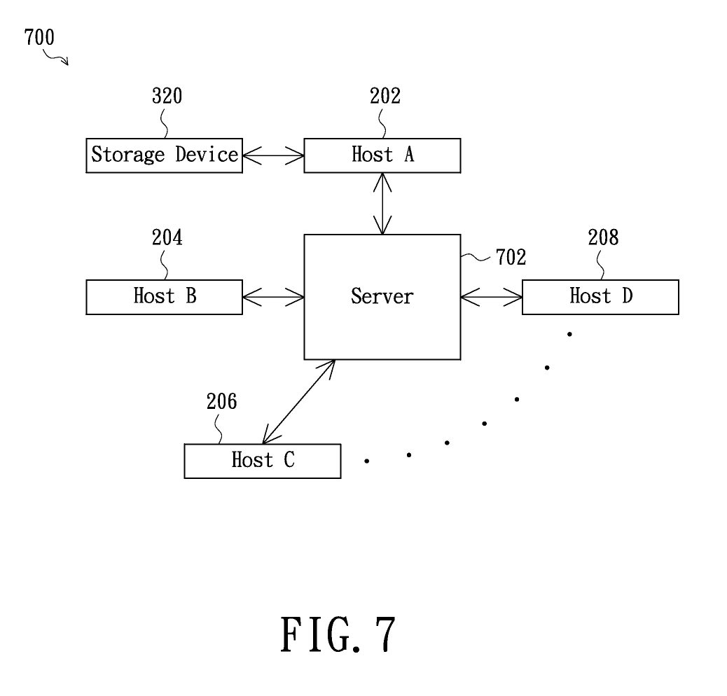

FIG. 7 is a block diagram of the sharing system according to another embodiment of the present invention. Referring to the FIG. 7, in this embodiment, a server 702 is provided to link all of the hosts, such as host A 202, host B 204, host C 206 and host D 208. In addition, the server 702 has the location information of all the hosts, such as the network addresses. Furthermore, an identification code is also saved into the server 702.

When the server 702 generates a linking request to one of the hosts, such like the host A 202, the CAPP (e.g., the CAPP 312 in the FIG. 3) would compare the identification code saved into the server 702 and the identification code in the storage device 320. When the identification codes of the server 702 and the storage device 320 are the same, the CAPP saved into the host A 202 makes the data transmission link between the server 702 and the host A 202 being established. Furthermore, the data sharing operation, the interruption operation and all messages (e.g., the selection-execution request) can be transmitted via the server 702.

Thus, the structure of the FIG. 7 can resolve a problem that each of the hosts cannot communicate by each other directly. Therefore, even each host cannot communicate with each other directly, all above data sharing operation shown in FIGS. 4 to 6 can still be performed through the server 702.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A storage media, having a control application program adapted for a host, when the application program is installed into the host, the steps performed by the control application program comprises:
checking whether or not a storage device links to the host;
checking whether or not an identification code of the storage device is accepted, when the storage device links to the host;
checking whether or not an another host communicates with the host linking with the storage device;
defining the host linking with the host as a server host, and the another host without linking the storage device as a client host, when finding out another host links to the host linking to the storage device; and
sharing a data with a sharable status of the storage device to the client host through the server host, when the identification code of the storage device is accepted.

2. The storage media according to claim 1, wherein the steps of sharing the data with the sharable status comprises:
saving a copy of a portion of the data with the sharable status of the storage device into the client host through the server host, when the client host links to the server host initially; and
transmitting complete data with the sharable status from the storage device to the client host through the server host for responding a selection-execution request from the client host.

3. The storage media according to claim 2, wherein the steps of transmitting complete data to the client host comprises:
generating a data stream; and
transmitting the data stream to the client host for responding the selection-execution request.

4. The storage media according to claim 2, wherein the step performed by the application program further comprises canceling the copy of the portion of the data with the sharing status for responding an interruption operation used for interrupting sharing the data saved in the storage device.

5. The storage media according to claim 4, wherein the interruption operation comprises interrupting the link between the storage device and the server host, changing the status of the data into an unsharable status, and enabling an interruption option.

6. The storage media according to claim 4, wherein the portion of the data with the sharable status comprises file name, fixing date, file classification and file size.

7. The storage media according to claim 1, wherein the steps of sharing the data with the sharable status comprises transmitting a copy complete data with the sharable status from the storage device to the client host through the server host, once the client host links to the server host.

8. The storage media according to claim 1, wherein the data with the sharable status is a single file or a file folder.

9. The storage media according to claim 1, wherein the classification of the data with the sharable status comprises a video file, an audio file, and a document file.

10. The storage media according to claim 1, wherein the step performed by the control application program further comprises providing a set window for a user to set the status of the data of the storage device.

11. The storage media according to claim 1, wherein the step of checking the identification code comprises checking whether or not the identification code is conformed with a predetermined code or a predetermined rule, or in a predetermined range.

12. The storage media according to claim 1, wherein the identification code is a production serial number of the storage device.

13. A data sharing method, suitable for a storage device and a host group having a plurality of hosts, comprises:
checking whether or not an identification code of the storage device is accepted, when the storage device links to one of the hosts;
defining the host linking with the host as a server host, and the rest of hosts without linking with the storage device as a client hosts, when the identification code of the storage device is accepted; and
broadcasting a notification to the client hosts from the server host, so as to perform a data sharing operation for sharing a data with a sharable status saved in the storage device to the client hosts through the server host.

14. The data sharing method according to claim 13, further comprises:
saving a control application program into the storage device; and
installing the control application program into the server host from the storage device as the storage device linking to the server host to make the control application program performing the data sharing operation.

15. The data sharing method according to claim 13, wherein the step of broadcasting the notification comprises broadcasting the notification through a network.

16. The data sharing method according to claim 15, wherein the network is a local network.

17. The data sharing method according to claim 13, further comprising:
providing a server;
saving the location information of the hosts into the server for establishing a data transmission link between the server and the hosts ; and
saving a identification code into the server.

18. The data sharing method according to claim 16, further comprising:
comparing the identification codes of the storage device with the identification code saved in the server; and
broadcasting the notification and sharing the data with the sharable status to the client host through the server, when the identification codes in the storage device and the server are the same.
